(19) United States
(12) Patent Application Publication
(10) Pub. No.: US 2014/0285503 A1
(43) Pub. Date: Sep. 25, 2014

(54) IMAGE DISPLAY METHOD, APPARATUS, AND PROGRAM

(71) Applicant: FUJIFILM Corporation, Tokyo (JP)

(72) Inventor: Taiji IWASAKI, Tokyo (JP)

(73) Assignee: FUJIFILM Corporation, Tokyo (JP)

(21) Appl. No.: 14/219,983

(22) Filed: Mar. 19, 2014

(30) Foreign Application Priority Data
Mar. 22, 2013 (JP) 2013-059662

(51) Int. Cl. G06T 1/20

(52) U.S. Cl. CPC G06T 1/20
USPC 345/522

(57) ABSTRACT

In an image display method that performs a plurality of types of processing operations a plurality of times in total, each an arbitrary number of times and order, on an image and each time a processing operation is performed once, stores a history of the processing operation in a storage unit, thereby allowing a switching display of an image in reverse of the order of the processing operations performed the plurality of times based on the stored history, when performing the switching display, if an instruction to display a next image is given from the state in which an image immediately after the performance of a specific processing operation is displayed, an image immediately before the performance of the specific processing operation is not displayed and an image immediately before the performance of a different processing operation performed immediately before the specific processing operation is displayed.

### BACKGROUND OF THE INVENTION

1. Field of the Invention

The present invention relates to an image display method and, more specifically, to an image display method that sequentially displays images before and after the performance of a plurality of certain processing operations in the order or in reverse of the order in which the processing operations were performed.

The invention is also relates to an image display apparatus for implementing the image display method described above and a program for causing a computer to perform the method.

2. Description of the Related Art

Heretofore, image display systems in which medical images, such as tomographic images and the like, are stored in a large-capacity storage means and the images are read out, as appropriate, from the storage means and displayed on a display means for diagnosis are known as described, for example, in Japanese Unexamined Patent Publication No. 2011-083590.

In this type of image display systems, various types of image processing operations, such as contrast adjustment, enhancement, and the like, are performed on an displayed image and images processed by the image processing operations are newly displayed in the past as described, for example, in Japanese Unexamined Patent Publication No. 2007-185429. Further, in this type of image display systems, image display related processing operations, such as paging (page feeding), panning (display area shifting), zooming (enlargement and reduction), and the like, are performed and images processed by the processing operations are newly displayed in the past.

When various types of processing operations are performed on a displayed image and images processed by the processing operations are displayed, it is often the case that an image before the performance of a processing operation is required to be displayed again. Such requirements arise, for example, in the case where the images before and after the performance of a processing operation need to be observed comparatively and further in the case where a more preferable image based on the comparative observation is required to be stored and retained.

As one of the methods that meet the demand described above, a method in which a history of processing operations is stored in a storage means and, if an undo instruction to cancel the previous processing operation is given, the image before the performance of the processing operation is generated based on the history and the generated image is displayed on a display means is known as described, for example, in Japanese Unexamined Patent Publication No. 2006-209543 (paragraphs [0043] and [0044]). Further, according to the method that uses such history, after a processing operation is cancelled, if a redo instruction of the processing operation is given, the processed image may be displayed again.

### SUMMARY OF THE INVENTION

As described above, the conventional method in which the history of a plurality of processing operations is stored in a storage unit and images before or after the processing operations are displayed based on the history, however, requires a lot of time and effort before a desired image is displayed. Further, a problem of annoyance may also exist because undesired images are also switched and displayed one by one. This problem becomes more significant as the number of undo and redo operations of processing is increased.

Consequently, it is an object of the present invention to provide an image display method capable of eliminating the annoyance described above and displaying a desired image from those before and after a plurality of processing operations with a little time and effort.

It is a further object of the present invention to provide an apparatus for implementing the image display method as described above and a program for causing a computer to perform the method.

A first image display method of the present invention is a method, including the steps of:

displaying an image in one display section of an image display unit;

performing a plurality of types of processing operations a plurality of times in total, each being performed an arbitrary number of times and order, on the displayed image;

each time a processing operation is performed once, changing the displayed image to an image processed by the processing operation; and

storing a history of the processing operations performed a plurality of times in a storage unit, thereby allowing a switching display of an image to be displayed in the display section in reverse of the order of the processing operations performed the plurality of times based on the stored history,

wherein, when performing the switching display, if an instruction to display a next image is given from the state in which an image immediately after the performance of a specific processing operation of the plurality of types of processing operations is displayed, an image immediately before the performance of the specific processing operation is not displayed and an image immediately before the performance of a processing operation which was performed immediately before the specific processing operation in the history and is different in type from the specific processing operation is displayed.

The term “specific processing operation” as used herein refers to a specific type of processing operation among a plurality of types and the specific processing operation may be one or more than one. This applies also to the invention described herein below.

In the case where the specific processing operation is more than one, the “specific processing operation” in the phrase of “performed immediately before the specific processing operation” refers to a collection of a plurality of specific processing operations.

The instruction to perform the switching display described above may be issued, by way of example, as an undo instruction to cancel the previous processing operation, as described above.

A second image display method according to the present invention is a method, including the steps of:

displaying an image in one display section of an image display unit;

performing a plurality of types of processing operations a plurality of times in total, each being performed an arbitrary number of times and order, on the displayed image;

each time a processing operation is performed once, changing the displayed image to an image processed by the processing operation; and

storing a history of the processing operations performed a plurality of times in a storage unit, thereby allowing a switching display of an image to be displayed in the display section in reverse of the order of the processing operations performed the plurality of times based on the stored history,

wherein, when performing the switching display, if an instruction to display a next image is given from the state in which an image immediately before the performance of a specific processing operation of the plurality of types of processing operations is displayed, an image immediately after the performance of the specific processing operation is not displayed and an image immediately after the performance of a processing operation which was performed immediately after the specific processing operation in the history and is different in type from the specific processing operation is displayed.

In the case where the specific processing operation is more than one, the “specific processing operation” in the phrase of “performed immediately after the specific processing operation” refers to a collection of a plurality of specific processing operations.

In the second image display method, the instruction to perform the switching display described above may be issued, by way of example, as a processing redo instruction as described above.

In the first and the second image display methods described above, the specific processing operation is preferably at least one of paging, panning, and zooming.

A third image display method according to the present invention is a method, including the steps of:

setting a plurality of areas in a display section of an image display unit and displaying an image in each area;

performing a processing operation a plurality of times in total, each being performed with respect to each area, on a plurality of images of the displayed images,

each time a processing operation is performed once, changing the displayed image to an image processed by the processing operation; and

storing a history of the processing operation performed a plurality of times in a storage unit, thereby allowing a switching display of images to be displayed in the display section in reverse of the order of the processing operation performed the plurality of times based on the stored history and in the same areas as originally displayed,

wherein, when performing the switching display, if a specific area of the plurality of areas is specified and an instruction to perform the switching display is given, the switching display is omitted for the images displayed in the areas other than the specific area.

Also in the third image display method, the instruction to perform the switching display described above may be issued, by way of example, as a processing undo instruction, as in the first image display method.

The first to the third image display methods of the present invention described above may be performed appropriately if the image is a medical image or an image stored in an image filing system.

A first program according to the present invention is a program for causing a computer to perform an image display method in an image display apparatus that:

displays an image in one display section of an image display unit;

performs a plurality of types of processing operations a plurality of times in total, each being performed an arbitrary number of times and order, on the displayed image;

each time a processing operation is performed once, changes the displayed image to an image processed by the processing operation; and

stores a history of the processing operations performed a plurality of times in a storage unit, thereby allowing a switching display of an image to be displayed in the display section in reverse of the order of the processing operations performed the plurality of times based on the stored history,

wherein, when performing the switching display, if an instruction to display a next image is given from the state in which an image immediately after the performance of a specific processing operation of the plurality of types of processing operations is displayed, the image display method does not display an image immediately before the performance of the specific processing operation and displays an image immediately before the performance of a processing operation which was performed immediately before the specific processing operation in the history and is different in type from the specific processing operation.

A second program according to the present invention is a program for causing a computer to perform an image display method in an image display apparatus that:

displays an image in one display section of an image display unit;

performs a plurality of types of processing operations a plurality of times in total, each being performed an arbitrary number of times and order, on the displayed image;

each time a processing operation is performed once, changes the displayed image to an image processed by the processing operation; and

stores a history of the processing operations performed a plurality of times in a storage unit, thereby allowing a switching display of an image to be displayed in the display section in reverse of the order of the processing operations performed the plurality of times based on the stored history,

wherein, when performing the switching display, if an instruction to display a next image is given from the state in which an image immediately before the performance of a specific processing operation of the plurality of types of processing operations is displayed, the image display method does not display an image immediately after the performance of the specific processing operation and displays an image immediately after the performance of a processing operation which was performed immediately after the specific processing operation in the history and is different in type from the specific processing operation.

A third program according to the present invention is a program for causing a computer to perform an image display method in an image display apparatus that:

sets a plurality of areas in a display section of an image display unit and displays an image in each area;

performs a processing operation a plurality of times in total, each being performed with respect to each area, on a plurality of images of the displayed images,

each time a processing operation is performed once, changes the displayed image to an image processed by the processing operation; and

stores a history of the processing operation performed a plurality of times in a storage unit, thereby allowing a switching display of images to be displayed in the display section in reverse of the order of the processing operation performed the plurality of times based on the stored history and in the same areas as originally displayed,

wherein, when performing the switching display, if a specific area of the plurality of areas is specified and an instruction to perform the switching display is given, the image display method omits the switching display for the images displayed in the areas other than the specific area.

A first image display apparatus according to the present invention is an apparatus that:

displays an image in one display section of an image display unit;

performs a plurality of types of processing operations a plurality of times in total, each being performed an arbitrary number of times and order, on the displayed image;

each time a processing operation is performed once, changes the displayed image to an image processed by the processing operation; and

stores a history of the processing operations performed a plurality of times in a storage unit, thereby allowing a switching display of an image to be displayed in the display section in reverse of the order of the processing operations performed the plurality of times based on the stored history,

wherein the image display apparatus includes a display control unit that, when performing the switching display, if an instruction to display a next image is given from the state in which an image immediately after the performance of a specific processing operation of the plurality of types of processing operations is displayed, does not display an image immediately before the performance of the specific processing operation and displays an image immediately before the performance of a processing operation which was performed immediately before the specific processing operation in the history and is different in type from the specific processing operation.

A second image display apparatus according to the present invention is an apparatus that:

displays an image in one display section of an image display unit;

performs a plurality of types of processing operations a plurality of times in total, each being performed an arbitrary number of times and order, on the displayed image;

each time a processing operation is performed once, changes the displayed image to an image processed by the processing operation; and

stores a history of the processing operations performed a plurality of times in a storage unit, thereby allowing a switching display of an image to be displayed in the display section in reverse of the order of the processing operations performed the plurality of times based on the stored history,

wherein the apparatus includes a display control unit that, when performing the switching display, if an instruction to display a next image is given from the state in which an image immediately before the performance of a specific processing operation of the plurality of types of processing operations is displayed, does not display an image immediately after the performance of the specific processing operation and displays an image immediately after the performance of a processing operation which was performed immediately after the specific processing operation in the history and is different in type from the specific processing operation.

A third image display apparatus according to the present invention is an apparatus that:

sets a plurality of areas in a display section of an image display unit and displays an image in each area;

performs a processing operation a plurality of times in total, each being performed with respect to each area, on a plurality of images of the displayed images,

each time a processing operation is performed once, changes the displayed image to an image processed by the processing operation; and

stores a history of the processing operation performed a plurality of times in a storage unit, thereby allowing a switching display of images to be displayed in the display section in reverse of the order of the processing operation performed the plurality of times based on the stored history and in the same areas as originally displayed,

wherein, the apparatus includes a display control unit that, when performing the switching display, if a specific area of the plurality of areas is specified and an instruction to perform the switching display is given, omits the switching display for the images displayed in the areas other than the specific area.

According to the first image display method of the present invention, when performing a switching display of an image to be displayed in the display section in reverse of the order of the processing operations performed a plurality of times, if an instruction to display a next image is given from the state in which an image immediately after the performance of a specific processing operation of the plurality of types of processing operations is displayed, an image immediately before the performance of the specific processing operation is not displayed and an image immediately before the performance of a processing operation which was performed immediately before the specific processing operation in the history and is different in type from the specific processing operation is displayed. This may reduce the time and effort required to display a desired image by the mount of not displaying an image immediately before the performance of the specific processing operation and annoyance that unnecessary images are displayed one by one is eliminated, whereby the work efficiency of image display may be improved.

According to the second image display method of the present invention, when performing a switching display of an image to be displayed in the display section in reverse of the order of the processing operations performed a plurality of times, if an instruction to display a next image is given from the state in which an image immediately before the performance of a specific processing operation of the plurality of types of processing operations is displayed, an image immediately after the performance of the specific processing operation is not displayed and an image immediately after the performance of a processing operation which was performed immediately after the specific processing operation in the history and is different in type from the specific processing operation is displayed. This may reduce the time and effort required to display a desired image by the mount of not displaying an image immediately after the performance of the specific processing operation and annoyance that unnecessary images are displayed one by one is eliminated, whereby the work efficiency of image display may be improved.

According to the third image display method of the present invention, when performing a switching display of images to be displayed in the display section in reverse of the order of the processing operation performed a plurality of times and in the same areas as originally displayed, if a specific area of the plurality of areas is specified and an instruction to perform the switching display is given, the switching display is omitted for the images displayed in the areas other than the specific area. This may reduce the time and effort required to display a desired image by the mount of the omission of the switching display and annoyance that unnecessary images are displayed one by one is eliminated, whereby the work efficiency of image display may be improved.

In the mean time, as described above, the first image display apparatus according to the present invention is an apparatus that:

displays an image in one display section of an image display unit;

performs a plurality of types of processing operations a plurality of times in total, each being performed an arbitrary number of times and order, on the displayed image;

each time a processing operation is performed once, changes the displayed image to an image processed by the processing operation; and

stores a history of the processing operations performed a plurality of times in a storage unit, thereby allowing a switching display of an image to be displayed in the display section in reverse of the order of the processing operations performed the plurality of times based on the stored history,

wherein the image display apparatus includes a display control unit that, when performing the switching display, if an instruction to display a next image is given from the state in which an image immediately after the performance of a specific processing operation of the plurality of types of processing operations is displayed, does not display an image immediately before the performance of the specific processing operation and displays an image immediately before the performance of a processing operation which was performed immediately before the specific processing operation in the history and is different in type from the specific processing operation. Therefore, the first image display apparatus may implement the first image display method according to the present invention.

As described above, the second image display apparatus according to the present invention is an apparatus that:

displays an image in one display section of an image display unit;

performs a plurality of types of processing operations a plurality of times in total, each being performed an arbitrary number of times and order, on the displayed image;

each time a processing operation is performed once, changes the displayed image to an image processed by the processing operation; and

stores a history of the processing operations performed a plurality of times in a storage unit, thereby allowing a switching display of an image to be displayed in the display section in reverse of the order of the processing operations performed the plurality of times based on the stored history,

wherein the apparatus includes a display control unit that, when performing the switching display, if an instruction to display a next image is given from the state in which an image immediately before the performance of a specific processing operation of the plurality of types of processing operations is displayed, does not display an image immediately after the performance of the specific processing operation and displays an image immediately after the performance of a processing operation which was performed immediately after the specific processing operation in the history and is different in type from the specific processing operation. Therefore, the second image display apparatus may implement the second image display method according to the present invention.

As described above, the third image display apparatus according to the present invention is an apparatus that:

sets a plurality of areas in a display section of an image display unit and displays an image in each area;

performs a processing operation a plurality of times in total, each being performed with respect to each area, on a plurality of images of the displayed images,

each time a processing operation is performed once, changes the displayed image to an image processed by the processing operation; and

stores a history of the processing operation performed a plurality of times in a storage unit, thereby allowing a switching display of images to be displayed in the display section in reverse of the order of the processing operation performed the plurality of times based on the stored history and in the same areas as originally displayed,

wherein, the apparatus includes a display control unit that, when performing the switching display, if a specific area of the plurality of areas is specified and an instruction to perform the switching display is given, omits the switching display for the images displayed in the areas other than the specific area. Therefore, the third image display apparatus may implement the third image display method according to the present invention.

### BRIEF DESCRIPTION OF THE DRAWINGS

FIG. 1 is a schematic configuration diagram of a medical information system that implements an image display method according to an embodiment of the present invention.

FIG. 2 is a perspective view of an image display apparatus in the system shown in FIG. 1, illustrating the configuration thereof.

FIG. 3 illustrates an example image display screen of the image display apparatus shown in FIG. 2.

FIG. 4 illustrates the transition of display images when the image display method is performed.

FIG. 5 is a partially enlarged view of the image display screen shown in FIG. 3.

FIG. 6 illustrates an example image display screen when an image display method according to an alternative embodiment of the present invention is performed.

FIG. 7 illustrates the transition of display images when the image display method according to the alternative embodiment of the present invention is performed.

FIG. 8 is a partially enlarged view of the image display screen shown in FIG. 6.

### DESCRIPTION OF THE PREFERRED EMBODIMENTS

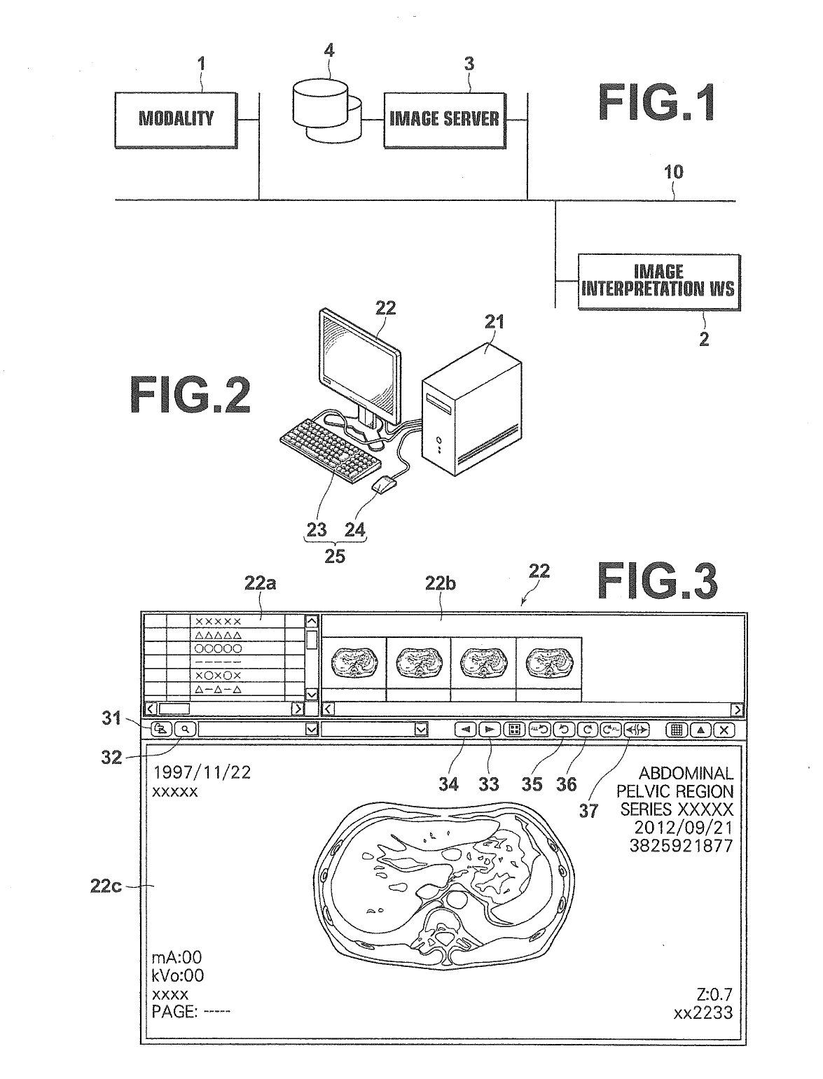

Hereinafter, embodiments of the present invention will be described in detail with reference to the accompanying drawings. FIG. 1 schematically illustrates the configuration of a medical information system to which an image display method according to the present invention is applied. The medical information system includes a medical image capturing apparatus (modality) 1, an image interpretation workstation 2 to which an image display method, as an embodiment of the present invention, is applied, an image server 3, and image database 4, which are communicatively linked to each other via a network 10. Each component of the present system is controlled by a program installed from a recording medium, such as a CD-ROM or the like. Note that the program may be downloaded from a server linked to the system by way of a network and installed.

The modality 1 includes equipment that performs imaging of an examination target region of a subject, generates image data of an image representing the region, and outputs the image data by attaching information (tag information), such as examination information, patient information, and the like, to the image data. The tag information described above is in a format that meets the standardized format, such as DICOM (Digital Imaging and Communication in Medicine) Standard and the like, or in a format that meets the standard format of the manufacture of the modality or the like. Specific examples of the modality 1 may include CT equipment, MRI equipment, PET equipment, ultrasonic imaging equipment, and the like.

In the present example, the image data for displaying the image are those representing a tomographic image of a subject obtained, by way of example, with CT equipment, and more specifically, a collection of image data representing axial section images or sagittal section images with a predetermined slice interval and slice thickness. Note that, however, the data dealt with by the image display apparatus of the present invention are not limited to such image data and the data may be other data, such as image data representing a mass of character information and the like.

The image interpretation workstation 2 is a system used by an image interpretation doctor, the user of the system, to perform image interpretation and generate an image interpretation report. As schematically illustrated in FIG. 2, the image interpretation workstation 2 is made up of a computer system which includes a processor 21 provided with a CPU, a storage unit, such as a hard disk, a memory and various types of interfaces, and the like, one or two of high definition displays (only one display is illustrated in the drawing), and an input means 25, such as a keyboard 23 and a mouse 24.

The image interpretation workstation 2 is configured to be able to issue an image retrieval request to the image server 3, perform various types of image processing operations on an image received from the image server 3, perform image display related operations, such as paging (page feeding), panning (display area shifting), and further zooming (enlargement and reduction), and the like, perform various analysis operations, including automatic detection and highlighting of a structure and a lesion like region in the image, display an image, support in generating an image interpretation report, issue a registration or retrieval request for an image interpretation report to an image interpretation report server (not shown), display an image interpretation report received from the image interpretation report server, and the like based on a program installed on the processor 21.

The image server 3 is a general purpose computer with relatively high processing power on which a software program that provides the function of the database management system (DataBase Management System: DBMS) is installed. Further, the image server 3 includes a large capacity storage constituting the image database 4. The storage may be a large capacity hard disk connected to the image server 3 by a data bus, a NAS (Network Attached Storage) connected to the network 10, or a disk unit connected to a SAN (Storage Area Network). The image server 3 also has a communication interface for communicating with the modality 1, image interpretation workstation 2, and the like via the network 10. When an image registration request is received from the modality 1, the image server 3 arranges the image into the database format and registers the image in the image database 4.

The image database 4 includes the image data of a three-dimensional image described above and the tag information related to the image. The tag information may possibly include, for example, the image ID for identifying each image, patient ID for identifying the subject, examination ID for identifying the examination, unique ID (UID) allocated to each image, examination date when the image was generated, examination time, the type of modality used in the examination for obtaining the image, patient information such as the name, age, and gender, and the like, examination region (imaged region), imaging information (imaging protocol, imaging sequence, imaging method, imaging condition, use of contrast agent, and the like), serial numbers or acquisition numbers when a plurality of images was obtained by one examination.

When a retrieval request is received from the image interpretation workstation 2 via the network 10, the image server 3 searches images registered in the image database 4 and sends an extracted image to the image interpretation workstation 2 that has issued the request.

When an operation for requesting retrieval of an image interpretation target image is performed by the user, such as the image interpretation doctor, the image interpretation workstation 2 sends the retrieval request to the image server 3 and obtains the image required for the image interpretation. Then, the image interpretation workstation 2 performs various types of image processing operations on the image, as well as the image display related operations, such as the paging, panning, and further zooming, based on the instructions from the user and then displays the image on the display 22.

The image display on the display 22 described above will now be described in detail. Note that one “examination” to be described herein below belongs to one “patient”. Further, one “examination” includes a plurality of “series”, and one “series” includes a plurality of “images”.

When “examination” is selected by the user (operator) from an examination list (not shown) displayed on the display 22, an image display screen as illustrated in FIG. 3 is displayed on the display 22. The image display screen includes, by way of example, an examination list display area 22a disposed on the upper left of the screen, a thumbnail display area 22b disposed on the right of the display area 22a, and an image display area 22c disposed on the lower side of the display areas 22a and 22b. Further, various types of operation buttons constituting GUI (Graphical User Interface) that allows the user to input various types of image display related instructions are displayed in a horizontal row on top of the image display area 22c.

Major buttons among the various types of operation buttons described above includes a reduction button 31 and an enlargement button 32 for instructing a zooming operation, a page feed button 33 and a page return button 34 for instructing a paging operation, an undo button 35 for cancelling a processing operation, such as an image processing operation or the aforementioned paging or the like, a redo button 36 for re-performing the same processing operation as that once cancelled, a history skip button 37 for instructing history skipping to be described later, and the like.

The examination list display area 22a displays an examination list for a patient. When an examination is selected in the list, the thumbnail display area is updated. One thumbnail image in a series belonging to the “examination selected in the examination list” is displayed in the thumbnail display area 22b.

When one of the thumbnail images is selected and the selected image is drag-and-dropped on a series display pane in the image display area 22c, the series of the drag source which includes the thumbnail image is displayed in the series display pane of the drop destination.

The image display area 22c may form one series pane as a whole or may display a plurality of series display panes by dividing the area, as illustrated in FIG. 6, to be described later. In the example shown in FIG. 6, four series are displayed in the layout of 2×2. Each series pane displays one series. When conducting image interpretation, the user carries out image interpretation while performing operations, for example, to change the gradation, the enlargement factor, and the like, on each image displayed in the image display area 22c. The operation on each image is mainly performed by clicking and dragging of the mouse 24.

In performing the processing operations of the buttons 31 to 37 described above, an instruction is given to the processor 21 based on the combination of moving a cursor displayed on the display 22 (not shown) with the mouse 24 and pressing the click button of the mouse 24, and the processing operation is performed by the processor 21 based on the instruction. That is, if, for example, the click button of the mouse 24 is pressed once with the cursor being placed on the reduction button 31, the image displayed on the display 22 is reduced by a predetermined ratio by the processor 21 and the display image is switched to the reduced image. The combined operation of the cursor setting and pressing of the click button of the mouse 24 described above is, hereinafter, referred to as “pressing the reduction button 31”. The same applies to the other display buttons. Further, if the enlargement button 32 is pressed once, the image displayed on the display 22 is switched to the image enlarged by a predetermined ratio.

When one of a series of a plurality of images related to each other and paginated, such as a plurality of images of different slice positions with respect to the same subject or a plurality of images different in date and time of imaging with respect to the same subject, is displayed on the display 22, if the page feed button 33 is pressed once, the processor 21 feeds the display target image by one page to the ascending side and the image of the next page is displayed on the display 22. Likewise, when one of the series of images is displayed on the display 22, if the page return button 34 is pressed once, the processor 21 feeds the display target image one page to the descending side and the image of the previous page is displayed on the display 22.

Further, it is also possible to cause a predetermined processing operation to be performed without using the aforementioned buttons 31 to 37. For example, when a certain image is displayed on the display 22, if the click button of the mouse 24 is pressed with the cursor being placed on the image and with that the mouse 24 is moved (drag operation), for example, in a horizontal direction, panning is performed in which the display image is moved to the same direction as that of the movement of the mouse 24.

So far the description has been made of a case in which an instruction to perform each processing operation is inputted via the GUI, but not limited to this, and an arrangement may be adopted in which an instruction to perform a processing operation is inputted using, for example, a particular key of the keyboard 23.

Further, the present embodiment allows image processing, such as contrast increase and decrease, edge enhancement, and the like, in addition to the image display related operations, such as the paging, panning, and zooming as described above. Details of the image processing operations will not be described here, but the image processing operations may be implemented in the same manner as in the conventional system. Even when these processing operations are performed, the display image may be changed from an image before the performance of the image processing operation to an image after the performance of the image processing operation.

In the present embodiment, it is possible, after the performance of a processing operation, such as paging, panning, or zooming, or one of the various types of image processing operations, to cancel the processing operation and display the image before the performance of the processing operation or further to display the image after re-performance of the processing operation from the state in which the image before the performance of the processing operation is displayed. The basic configuration for that purpose is identical to that in the conventional system, in which a history of processing operations is stored in the memory of the processor 21 and when an undo instruction of a processing operation or a redo instruction of a processing operation is inputted to the processor 21, an image after the performance of an undo operation or an image after the performance of a redo operation is generated based on the history and the generated image is displayed on the display 22. Hereinafter, the image immediately after the performance of the undo operation as described above is sometimes referred also to as “an undo image” and the image immediately after the performance of the redo operation is sometimes referred also to as “a redo image”.

The instruction to perform the undo operation and the instruction to perform the redo operation described above are given to the processor 21 by pressing the undo button 35 and the redo button 36 shown in FIG. 3 respectively. Further, each time the history skip button 37 is pressed once, an instruction to set a mode in which history skipping is performed (hereinafter, referred to as “history skipping mode”) and an instruction to set a mode in which history skipping is not performed (hereinafter, referred to as “normal mode”) are inputted to the processor 21 in an alternately switched manner. While the history skipping mode is set, the display of the history skip button 37 is reversed, blinked, or colored to clearly indicate that the history skipping mode is set.

The aforementioned history skipping is a function, when sequentially displaying images before and after each processing operation following or in reverse of the order in which a plurality of processing operations was performed, not to display an image determined not necessary to be displayed. For example, the aforementioned paging is an operation to feed and display images one by one in order to find an image the user wants to observe. Therefore, it is often the case that the images displayed through page feeding until the desired image is found are not particularly necessary to redisplay one by one.

Hereinafter, the transition of display images when an undo operation of processing and a redo operation of processing are performed will be described in detail. A description will be made first of a case in which an undo operation of processing and a redo operation of processing are performed in the normal mode. In the case where images are transitionally displayed in the normal mode, the history skip button 37 shown in FIG. 3 is operated in the manner as described above and the normal mode is set.

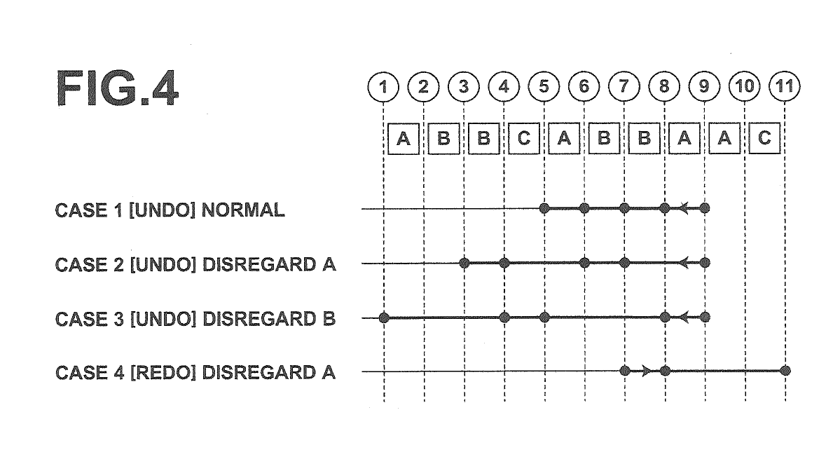

FIG. 4 illustrates examples of transition states of images displayed in the image display area 22c of the display 22 when the aforementioned undo operation of processing and the redo operation of processing are performed. It is assumed here that the paging, panning, and zooming, and three types of image processing operations A, B, and C will be performed and these image processing operations are represented by rectangles. The number and the order of the processing operations shown here are merely examples and these processing operations may be performed arbitrary number of times and order. Further, images displayed before and after these processing operations are represented by circles with numbers 1, 2, 3, - - - , 11 attached thereto in the order in which the images are displayed, i.e., in the order in which a plurality of processing operations is performed (in the order from left to right in the drawing). The transition of display images is indicated by a heavy horizontal line and the states in which images are displayed are indicated by black circles on the horizontal line.

In FIG. 4, CASE 1 indicates the transition state of display image when an undo operation of processing is performed in the normal mode. That is, for example, if the undo button 35 is pressed once under the state in which the image 9 immediately after the performance of the processing A is displayed, an instruction to generate an image after the performance of an undo operation of the processing A on the image 9, i.e., an undo image 8, is inputted to the processor 21 and the display image is switched to the generated undo image 8. Then, each time the undo button is further pressed once, the display image is switched one by one to the image after the performance of the undo operation, like image 7→image 6→image 5. In this way, each time the undo button is pressed once, the image is displayed in reverse of the processing order in the history one by one in the normal mode. As is clear from the aforementioned description, the processor 21 constitutes the display control unit of the present invention.

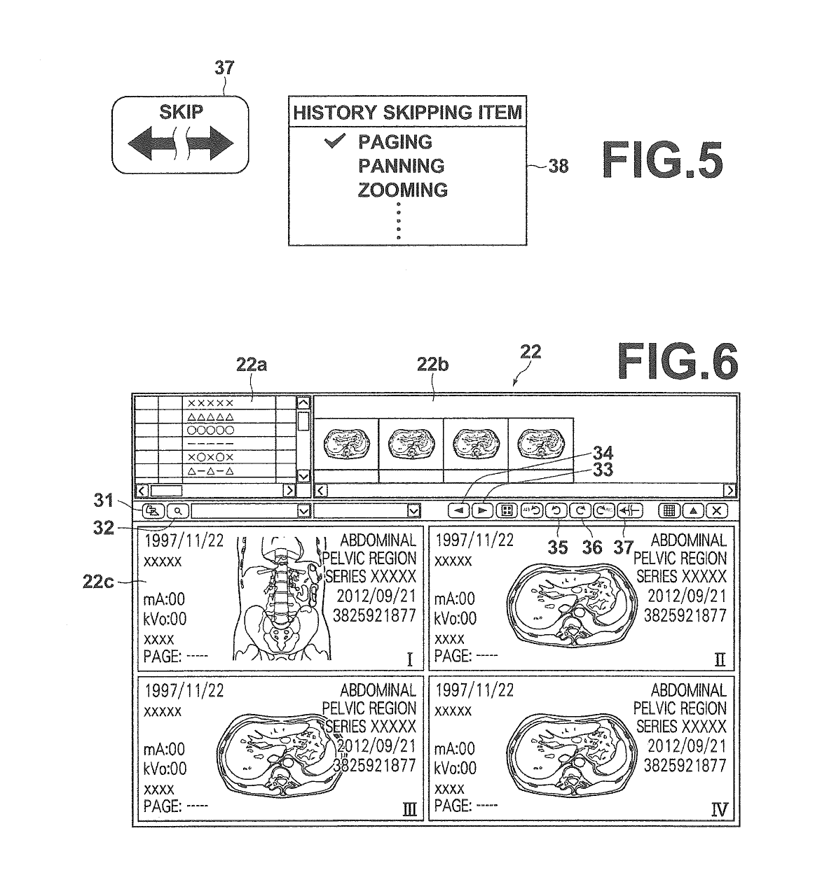

Next, a description will be made of a case in which an undo operation of processing and a redo operation of processing are performed under the history skipping mode. In the case where images are transitionally displayed in the history skipping mode, the history skip button 37 is operated in the manner as described above and the history skipping mode is set. When the history skipping mode is set in the manner as described above, a small window 38 is opened near the history skip button 37 on the display 22, as illustrated in FIG. 5. The window 38 displays the names of processing operations that can be the targets of the history skipping, and a specific processing operation may be selected and set from these names as a history skipping target. That is, for example, if the click button of the mouse 24 is pressed with a cursor (not shown) being placed on the display of the “PAGING”, a check mark indicating the selection is displayed on the left side of the “PAGING” and an instruction to treat the paging as the target of history skipping is inputted to the processor 21. Thereafter, the window 38 is erased automatically.

In the example of FIG. 5, only one specific processing operation (paging) is selected and set, but an arrangement may be adopted in which a plurality of specific processing operations is selected and set.

The transition states of display images when an undo operation of processing is performed under the history skipping mode are shown in CASE 2 and CASE 3 in FIG. 4. As an example, CASE 2 illustrates the case in which the history skipping target is the processing A and the display of the undo image is disregarded, while CASE 3 illustrates the case in which the history skipping target is the processing B and the display of the undo image is disregarded. In CASE 2, if the undo button 35 is pressed once under the state in which the image 9 immediately after the performance of the processing A is displayed, an instruction is inputted to the processor 21 to generate an image after the performance of an undo operation of the processing A on the image 9, i.e., the undo image 8 without displaying the image 8, then to generate the undo image 7 of the processing B which is the immediately preceding processing in the processing order in the history and not the history skipping target, and the display image is switched to the image 7. Then, if the undo button 35 is pressed once, the undo image 6 of the processing B which is not the history skipping target is generated and displayed. Thereafter, if the undo button 35 is pressed once, the undo image 5 of the processing A is generated (image 5 is not displayed), then the undo image 4 of the processing C which is the immediately preceding processing in the processing order and not the history skipping target is generated and displayed. Then, if the undo button 35 is pressed once, the undo image 3 of the processing B which is not the history skipping target is generated and displayed.

If images are switched and displayed in the manner as described above, for example, the pressing of the undo button 35 four times allows returning to image 3 while the same button pressing of four times allows returning only to image 5 in the normal mode. In this way, according to the present invention, the annoyance that the undo images not deemed particularly necessary are displayed one by one is eliminated and the time and effort required for returning to a desired image are reduced, whereby the work efficiency of image display may be improved.

Next, in CASE 3 in FIG. 4, if the undo button 35 is pressed once under the state in which the image 9 immediately after the performance of the processing A is displayed, an instruction to generate and display the undo image 8 of the processing A which is not the history skipping target is inputted to the processor 21 and the display image is switched to the image 8. Thereafter, if the undo button 35 is pressed once, undo images 7 and 6 of the processing B (two times) which is the history skipping target are generated (the images 7 and 6 are not displayed), and the undo image 5 of the processing A immediately preceding operation in the processing order and not the history skipping target is generated and displayed. Then, if the undo button 35 is pressed once, the undo image 4 of the processing C which is not the history skipping target is generated and displayed. Next, if the undo button 35 is pressed once, the undo images 3 and 2 of the processing B (two times) which is the history skipping target are generated (the images 3 and 2 are not displayed) and then the undo image 1 of the processing A which is the immediately preceding operation in the processing order and not the history skipping target is generated and displayed.

If images are switched and displayed in the manner as described above, for example, the pressing of the undo button 35 four times allows returning to image 1 while the same button pressing of four times allows returning only to image 5 in the normal mode, whereby the work efficiency of image display may be improved. The effect of improving the work efficiency becomes more significant as the number of processing operations which are the history skipping targets included in the process of returning to the desired image is increased, as is clear from the comparison between CASE 2 and CASE 3 described above. Here also, the annoyance that the undo images not deemed particularly necessary are displayed one by one is eliminated.

Next, image display when a redo operation of processing is performed after the undo operation of processing described above is performed will be described.

The redo operation of processing in the normal mode will be described first with reference to CASE 1 in FIG. 4. As illustrated in the drawing, when the redo operation of processing is performed after the undo operation of processing is performed several times, the redo button 36 is pressed. That is, each time the redo button 36 is pressed once, each processing operation is performed according to the processing history and display image is switched to image 6→image 7→image 8→image 9 from the state in which the undo button 35 has been pressed four times and the image 5 is displayed, as in the example of the normal mode described above.

The redo operation of processing under the history skipping mode will be described with reference to CASE 4 in FIG. 4. Here, a description will be made of a case in which a redo operation of processing is performed from the state in which undo operations of processing have been performed several times after image 11 is displayed and image 7 is displayed. It is assumed here that the history skipping target is the processing A. If the redo button 36 is pressed once while the image 7 is displayed, the processing B which is not the history skipping target is performed and the redo image 8 immediately after the performance of the processing is displayed. Then, if the redo button 36 is pressed once, the processing A is performed (two times, redo images 9, 10 of each processing operation are not displayed) and then the redo image 11 to which the processing C which is immediately following in the processing order and not the history skipping target has been performed is generated and displayed.

While the normal mode requires the pressing of the redo button 36 four times for returning from image 7 to image 11, the aforementioned history skipping requires only two times of the pressing of the redo button 36, whereby work efficiency of image display may be improved. In this case also, the annoyance that the redo images not deemed particularly necessary are displayed one by one is eliminated.

In the embodiment described above, the entire image display area 22c constitutes one display section and the image display method of the present invention is applied to the image display in the display section. In the case where a plurality of series display panes is displayed by dividing the image display area 22c, as illustrated in FIG. 6, the image display method of the present invention may also be applied to the image display in each of these series display panes.

Further, a plurality of specific processing operations may be set as the history skipping targets, as described above. For example, in the example shown in FIG. 4, in the case where the processing A and processing B are set as the history skipping targets, if undo button 35 is pressed once under the state in which the image 9 is displayed, the undo image 4 of the processing C will be generated and displayed.

Next, an alternative embodiment of the present invention will be described. FIG. 6 illustrates an example display screen when the image display method of the present embodiment is implemented. In FIG. 6, elements identical to those already described are given the same reference numbers and will not be elaborated upon further here, unless specifically required (the same applies hereinafter). As described earlier, four series display panes are set on the image display screen and each series display pane is an area in which an image is displayed individually. The names of the areas individually given to each of the series display panes, I, II, III, and IV are displayed on the lower right of each series display pane.

Hereinafter, the transition of display images in the present embodiment will be described. Also, in the present embodiment, processing history is stored in the memory of the processor 21 and when an undo instruction of processing is inputted to the processor 21, an undo image of processing is generated based on the history and the image is displayed on the display 22. Further, the normal mode and the history skipping mode described above may be alternatively selected also in the present embodiment, but the history skipping mode is set only in the case where an undo operation of processing is performed.

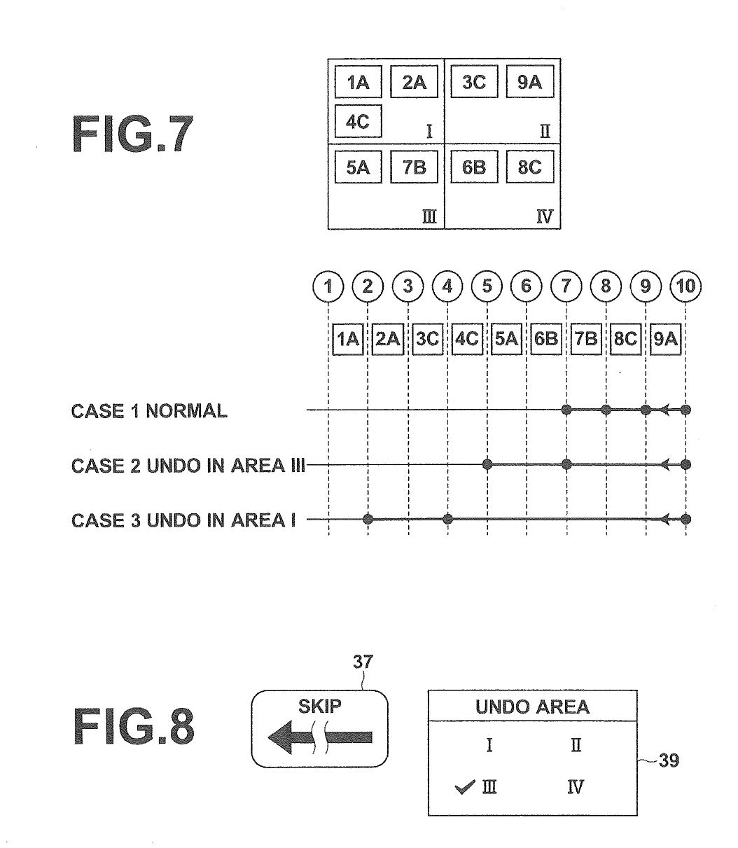

A description will be made first of a case in which an undo operation of processing is performed in the normal mode. In the case where images are transitionally displayed in the normal mode, the history skip button 37 shown in FIG. 6 is operated in the same manner as described above and the normal mode is set. One example transition state of images displayed on the image display area 22c of the display 22 is illustrated in the lower half of FIG. 7. It is assumed here that the paging, panning, and zooming, and three types of image processing operations A, B, and C will be performed and these image processing operations are represented by rectangles. Each type of the processing operations A, B, and C has a prefix number which indicates the order in which it is performed. For example, “2A” indicates the type A processing operation performed in the second of the nine processing operations in total. Images displayed before and after these processing operations are represented by circles with numbers 1, 2, 3, - - - , 10 attached thereto in the order in which the images are displayed, i.e., in the order in which a plurality of processing operations is performed (in the order from left to right in the drawing). The transition of display images is indicated by a heavy horizontal line and the states in which images are displayed are indicated by black circles on the horizontal line.

The upper half of FIG. 7 illustrates the transition state of images in each of the four display areas I, II, III, and IV. More specifically, the first and second processing is the processing A performed on the display image in the area I, the third processing is the processing C performed on the display image in the area II, the fourth processing is the processing C performed on the display image in the area I, the fifth processing is the processing A performed on the display image in the area III, - - - (skipped) - - - , and the final and the ninth processing is the processing A performed on the display image in the area II. The number and the order of the processing operations shown here are merely examples and these processing operations may be performed an arbitrary number of times and order on the image displayed in any image display area.

In FIG. 7, CASE 1 indicates the transition state of display image when an undo operation of processing is performed in the normal mode. That is, if the undo button 35 is pressed once under the state in which the image 10 is displayed in the image display area 22c (the state in which the image after the performance of the processing 4C is displayed in the area I, the image after the performance of the processing 9A is displayed in the area II, the image after the performance of the processing 7B is displayed in the area III, and an image after the performance of the processing 8C is displayed in the area IV), an instruction to generate and display an image before the performance of the processing 9A is inputted to the processor 21 and the display image in the image display area 22c changed to image 9 in which only the display image in the area II is switched to an image before the performance of the processing 9A. Then, if the undo button 35 is pressed once, an instruction to generate and display an image before the performance of the processing 8C is inputted to the processor 21 and the display image in the image display area 22c is changed to image 8 in which only the display image in the area IV is switched to an image before the performance of the processing 8C. Likewise, thereafter, each time the undo button 35 is pressed once, the processed image displayed in any one of the display areas is switched and displayed to an image before the performance of the processing. In this case also, the processor 21 constitutes the display control unit of the present invention.

Next, a description will be made of a case in which an undo operation of processing is performed under the history skipping mode. In the case where images are transitionally displayed in the history skipping mode, the history skip button 37 is operated in the manner as described above and the history skipping mode is set. When the history skipping mode is set in the manner as described above, a small window 39 is opened near the history skip button 37 on the display 22, as illustrated in FIG. 8. The window 39 displays the names I, II, III, and IV of the areas to allow the selection and setting of an area for which an undo operation of processing is performed. That is, for example, if the click button of the mouse 24 is pressed with a cursor (not shown) being placed on the display of “III”, a check mark indicating the selection is displayed on the left side of the “III” and an instruction to perform an undo operation of processing only in the area III is inputted to the processor 21. Thereafter, the window 39 is erased automatically.

In the example of FIG. 8, only the area III is selected and set as the area in which an undo operation of processing is performed, but an arrangement may be adopted in which a plurality of areas is selected and set.

The transition states of display images when an undo operation of processing is performed under the history skipping mode are shown in CASE 2 and CASE 3 in FIG. 7. As an example, CASE 2 illustrates the case in which the processing skipping target is only the area III, while CASE 3 illustrates the case in which the processing skipping target is only the area I. In CASE 2, if the undo button 35 is pressed once under the state in which the image 10 is displayed as described above, undo images tracing back the history are generated for the areas I, II, and IV other than the area III (areas II and IV, to be specific in this example) but their switching display is omitted and undo image generation and switching display are performed only for the area III. That is, the display image in the image display area 22c is changed to the image 7 in which the display image in the area III is switched to the image before the performance of the processing 7B.

In a strict sense, in comparison with the image 7 transitioned after undo operations of processing are performed three times in the normal mode, the image 7 here differs in that the processing operations 9 and 8 are not cancelled, i.e., the display images in the areas II and IV are not switched, but it is called as “image 7” for the sake of convenience (the same applies hereinafter). As such performance of undo operation of processing only in the area III is normally implemented in the case where the user is not interested in the transitions of the display images of the other areas, I, II, and IV, the non-performance of one by one display of the undo images in the areas other than the area III does not generally cause any inconvenience.

Next, if the undo button 35 is pressed once, undo images tracing back the history are generated for the areas I, II, and IV other than the area III (areas IV, to be specific in this example) but their switching display is omitted and undo image generation and switching display are performed only for the area III. That is, the display image in the image display area 22c is changed to the image 5 in which the display image in the area III is switched to the image before the performance of the processing 5A.

As described above, whereas the normal mode requires the pressing of the undo button 35 five times for returning from the image 10 to the image 5, the performance of the aforementioned history skipping allows the number of pressing times of the undo button 35 to be reduced only to two times, whereby the work efficiency of image display may be improved.

Next, CASE 3 in FIG. 7, i.e., the case where the undo operation target of processing is only the area I, will be described. In this case, if the undo button 35 is pressed once under the state in which the image 10 is displayed as described above, undo images tracing back the history are generated for the areas II, III, and IV other than the area I but their switching display is omitted and undo image generation and switching display are performed only for the area I. That is, the display image in the display area 22c is changed to the image 4 in which the display image in the area I is switched to the image before the performance of the processing 4C.

Next, if the undo button 35 is pressed once, undo images tracing back the history are generated for the areas II, III, and IV other than the area I (areas II, to be specific in this example) but their switching display is omitted and undo image generation and switching display are performed only for the area I. That is, the display image in the image display area 22c is changed to the image 2 in which the display image in the area I is switched to the image before the performance of the processing 2A.

So far the present embodiment has been described, but the present invention is not limited to the embodiments described above and modifications and changes may be made as appropriate without departing from the technical concept of the present invention. For example, in the embodiments described above, the present invention is applied to the case where medical images are displayed but the present invention may also be applied equally to the case where images other than medical images are displayed.

As for the images, other than the medical images, to which the present invention is applicable may includes general photographic images and other images generated by so-called computer graphics techniques, images formed of a mass of textual information, and the like. In the display of such types of images, processing operations, such as paging and zooming, and image processing operations, such as brightness change, tone change, and the like, may possibly be performed and there may be a case in which history skipping for these processing operations is desirable.

A program for causing a computer to perform the steps of the image display method according to the present invention described above is one of the embodiments of the present invention. Further, a computer readable recording medium on which is recorded such program is also one of the embodiments of the present invention.

What is claimed is:

1. An image display method, comprising the steps of:
displaying an image in one display section of an image display unit;
performing a plurality of types of processing operations a plurality of times in total, each being performed an arbitrary number of times and order, on the displayed image;
each time a processing operation is performed once, changing the displayed image to an image processed by the processing operation; and
storing a history of the processing operations performed a plurality of times in a storage unit, thereby allowing a switching display of an image to be displayed in the display section in reverse of the order of the processing operations performed the plurality of times based on the stored history,
wherein, when performing the switching display, if an instruction to display a next image is given from the state in which an image immediately after the performance of a specific processing operation of the plurality of types of processing operations is displayed, an image immediately before the performance of the specific processing operation is not displayed and an image immediately before the performance of a processing operation which was performed immediately before the specific processing operation in the history and is different in type from the specific processing operation is displayed.

2. The image display method of claim 1, wherein the instruction to perform the switching display is issued as an undo instruction to cancel the previous processing operation.

3. The image display method of claim 1, wherein the specific processing operation is at least one of paging, panning, and zooming.

4. The image display method of claim 1, wherein the image is a medical image.

5. The image display method of claim 1, wherein the image is an image stored in an image filing system.

6. An image display method, comprising the steps of:
displaying an image in one display section of an image display unit;
performing a plurality of types of processing operations a plurality of times in total, each being performed an arbitrary number of times and order, on the displayed image;
each time a processing operation is performed once, changing the displayed image to an image processed by the processing operation; and
storing a history of the processing operations performed a plurality of times in a storage unit, thereby allowing a switching display of an image to be displayed in the display section in reverse of the order of the processing operations performed the plurality of times based on the stored history,
wherein, when performing the switching display, if an instruction to display a next image is given from the state in which an image immediately before the performance of a specific processing operation of the plurality of types of processing operations is displayed, an image immediately after the performance of the specific processing operation is not displayed and an image immediately after the performance of a processing operation which was performed immediately after the specific processing operation in the history and is different in type from the specific processing operation is displayed.

7. The image display method of claim 6, wherein the instruction to perform the switching display is issued as a redo instruction to re-perform a processing operation once performed.

8. The image display method of claim 6, wherein the specific processing operation is at least one of paging, panning, and zooming.

9. The image display method of claim 6, wherein the image is a medical image.

10. The image display method of claim 6, wherein the image is an image stored in an image filing system.

11. An image display apparatus that:
displays an image in one display section of an image display unit;
performs a plurality of types of processing operations a plurality of times in total, each being performed an arbitrary number of times and order, on the displayed image;
each time a processing operation is performed once, changes the displayed image to an image processed by the processing operation; and
stores a history of the processing operations performed a plurality of times in a storage unit, thereby allowing a switching display of an image to be displayed in the display section in reverse of the order of the processing operations performed the plurality of times based on the stored history,
wherein the image display apparatus comprises a display control unit that, when performing the switching display, if an instruction to display a next image is given from the state in which an image immediately after the performance of a specific processing operation of the plurality of types of processing operations is displayed, does not display an image immediately before the performance of the specific processing operation and displays an image immediately before the performance of a processing operation which was performed immediately before the specific processing operation in the history and is different in type from the specific processing operation.

12. An image display apparatus that:
displays an image in one display section of an image display unit;
performs a plurality of types of processing operations a plurality of times in total, each being performed an arbitrary number of times and order, on the displayed image;
each time a processing operation is performed once, changes the displayed image to an image processed by the processing operation; and
stores a history of the processing operations performed a plurality of times in a storage unit, thereby allowing a switching display of an image to be displayed in the display section in reverse of the order of the processing operations performed the plurality of times based on the stored history,
wherein the apparatus comprises a display control unit that, when performing the switching display, if an instruction to display a next image is given from the state in which an image immediately before the performance of a specific processing operation of the plurality of types of processing operations is displayed, does not display an image immediately after the performance of the specific processing operation and displays an image immediately after the performance of a processing operation which was performed immediately after the specific processing operation in the history and is different in type from the specific processing operation.
